(19) United States
(12) Patent Application Publication
(10) Pub. No.: US 2008/0301005 A1
(43) Pub. Date: Dec. 4, 2008

(54) Collective gift system

(76) Inventors: Michelle Fujiko Nieda, Los Altos, CA (US); Paula Marie Cho, Los Altos, CA (US)

Correspondence Address: MCDERMOTT, WILL & EMERY LLP, 227 WEST MONROE STREET, SUITE 4400, CHICAGO, IL, 60606-5096, US

(21) Appl. No.: 12/156,095

(22) Filed: May 29, 2008

Related U.S. Application Data
(60) Provisional application No. 60/932,502, filed on May 30, 2007.

(51) Int. Cl. G06Q 30/00

(52) U.S. Cl. 705/27

(57) ABSTRACT

An Internet business model comprises a website that allows an Organizer to log-in and initiate a collective gift from many Contributors that are then presented to the Recipient in the form of a Gift Card. Each contributor provides credit card information and an authorization only is obtained. The actual charge is put through only after the gift is fully subscribed and the collection period has ended. Then the gift card is funded and issued. Fees for the collective gift service may be paid in full by the Organizer, a Sponsor, partitioned amongst the Contributors, or covered as an advertizing or merchandizing expense by the gift card issuer.

### CROSS-REFERENCE TO RELATED APPLICATIONS

The present invention claims priority to U.S. Provisional Patent Application 60/932,502, filed May 30, 2007, pursuant to 35 U.S.C. § 119. The disclosure of U.S. Provisional Patent Application No. 60/932,502 is incorporated herein in its entirety.

### FIELD OF THE PRESENT INVENTION

The present invention relates to gift giving services, and in particular to Internet business model implementations, websites, and methods that allow an Organizer to initiate a collective gift from many Contributors that are then presented to the Recipient in the form of a Gift Card.

### BACKGROUND

Individuals often organize groups they belong to get together and buy a gift for a teacher, coach, club leaders, and others having birthdays, anniversaries, baby showers, weddings, etc. A common office experience in America is where everyone “joins together” to collectively buy a relatively expensive gift for someone in the office, e.g., for a service anniversary, retiring, relocating, etc. Usually one particular person starts the ball rolling by announcing the effort, coordinating the collection of the money, and actually going out and purchasing the gift.

Modern offices, co-workers, and friends are now far-flung and not all located within one small area. But, more and more people all now share email and the Internet. Credit-card style gift cards are also a new modern convenience that many people like to receive because such payment cards offer a lot of flexibility in where they can be used.

Gift cards are attractive for the recipients because they have some flexibility in what they can buy, so what ultimately gets purchased is something the gift givers might not have anticipated. Issuers of gift cards have found that gift card issuance can be very profitable for them, and an excellent way to merchandize their products. They can afford to offer discounts and loyalty programs because the cards sell for 100% of face value, but on average, far less than 100% of the value is ultimately consumed. Misplaced cards, and cards going expired further add to the bottom-line profits.

### SUMMARY OF THE PRESENT INVENTION

Briefly, an Internet business model embodiment of the present invention comprises a website that allows an Organizer to log-in and initiate a collective gift from many Contributors that are then presented to the Recipient in the form of a Gift Card. Each contributor provides credit card information and an authorization only is obtained. The actual charge is put through only after the gift is fully subscribed and the collection period has ended. In some cases, for example, when the gift total reaches a minimum of $50.00, the actual charges are put through before the collection period has ended. Then the gift card is funded and issued. Fees for the collective gift service may be paid in full by the Organizer, a Sponsor, partitioned amongst the Contributors, or covered as an advertizing or merchandizing expense by the gift card issuer.

An advantage of the present invention is a web-organized way is provided to make a collective gift from several people.

Another advantage of the present invention is a business model is provided for generating income from collective gift giving.

A further advantage of the present invention is a service is provided for organizers and collective gift contributors to get together and combine to make a relatively expensive and useful gift.

A still further advantage of the present invention is a method is provided that allows users to contribute from their homes and offices, they never have to meet face-to-face in order to participate. This means such users can be in different locations and time zones, and could even be anonymous.

An advantage of the present invention is a web-organized way is provided to make a collective gift from people included by their emails, and email use is now universal, so no one will be left out.

A further advantage of the present invention is a service is provided in which seeing the names of other potential contributors helps stimulate a contribution to a collective gift.

The above summary of the present invention is not intended to represent each disclosed embodiment, or every aspect, of the present invention. Other aspects and example embodiments are provided in the figures and the detailed description that follow.

### BRIEF DESCRIPTION OF THE DRAWINGS

The present invention may be more completely understood in consideration of the following detailed description of various embodiments of the present invention in connection with the accompanying drawings, in which:

FIG. 1 is a flowchart diagram of collective gift giving business model embodiment of the present invention showing the steps and interrelationships taken between an Organizer, a Website, various Contributors, and a targeted Recipient;

FIG. 2 is a flowchart diagram representing how a bank authorization is obtained for each contributor's credit card at the time of their contribution, and how these all remaining pending until they are submitted for payment by the gift deadline date; and

FIG. 3 is a flowchart diagram showing alternative ways the Website operation fees can be supported by the Organizer, Contributors, and/or Sponsors.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention as defined by the appended claims.

### DETAILED DESCRIPTION

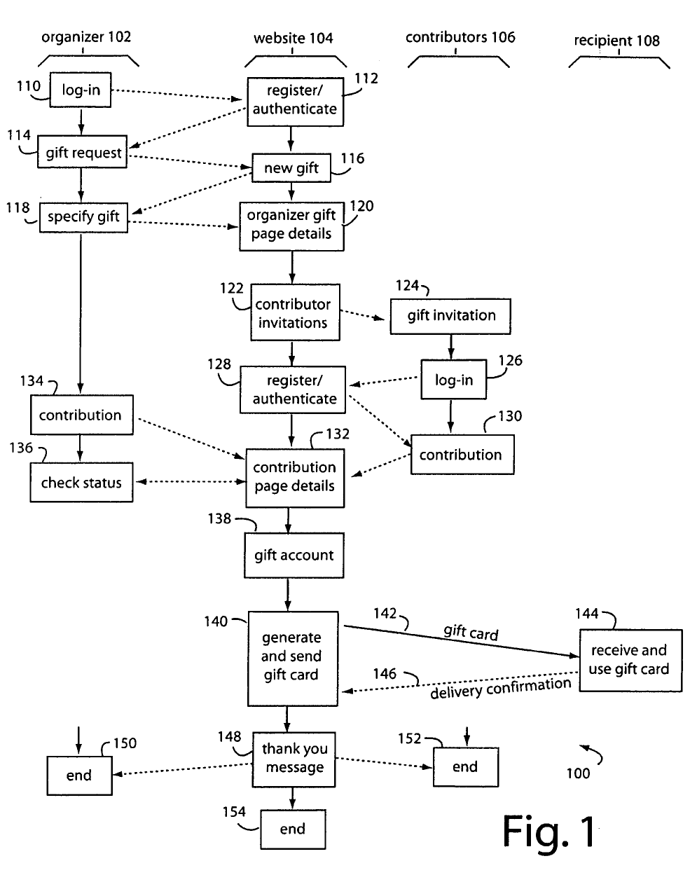

FIG. 1 represents a collective gift giving business model embodiment of the present invention, and is referred to herein by the general reference numeral 100. The collective gift giving business model 100 involves an organizer 102, a website 104, a number of contributors 106, and a gift recipient 108. The organizer 102 and the contributors 106 communicate with the website 104 over the Internet using web browsers like Internet Explorer, web pages as provided by APACHE HTTP, Microsoft IIS servers, etc., and email. The recipient 108 need not necessarily have online access to the Internet or email because the gift can be delivered to their door.

The operational objective of business model 100 is to generate business income for website 104, provide an affordable gift-giving service to organizer 102 and contributors 106, and to deliver a useful and valuable gift to recipient 108.

The collective gift giving business model 100 comprises many interrelated and sequential steps amongst all the parties involved. A step 110 begins the process with a log-in from a typical web browser on a web server's webpage. Website 104 runs a new-user registration and existing user log-in authentication step 112. The organizer 102 then announces a new gift request in a step 114. The website 104 opens a new gift account in a step 116 and invites the organizer to provide all the required details. The organizer 102 supplies details about who they are, who the recipient is, the proposed gift, a list of possible contributors. A service fee can be paid in a step 118 by the organizer, a sponsor, the contributors, or even an advertiser. The gift details are organized in a step 120, and in one embodiment of the present invention, payment is accepted and processed.

The website 104 then issues invitations by email, in a step 122, to all the contributors that were suggested. These emails are received by the contributors 106 in a step 124 which include links that can be clicked-on to access the gift-giving details. If an individual contributor 106 decides to investigate further or to participate, they can log-in to website 104 with an email link in a step 126. A step 128 presents a typical new-user registration and existing user log-in authentication web page.

Alternatively, and perhaps more attractive for some users, contributors are not required to log-in. When a contributor 106 receives their email, a link is provided in the email that allows them to click on it and go directly to a link with the gift-giving details. Each contributor decides to participate by making their payment in a step 130. The details of all the gift contributions are collected and summarized in a step 132, and also in future versions of step 124. The individual names of the contributors and the amounts they respectively contributed can be suppressed so others will not see. The organizer 102 must make a contribution in a step 134. The current status can be viewed in a step 136.

A step 138 represents when a gift account target date has been reached, or time has expired. The website 104 can impose a minimum gift amount, e.g., $50. Once it has been determined that all the gift contributions are in, or time is up, then a step 140 generates and sends a gift card 142 to either the recipient 108, the organizer 102 or a different shipping address. The recipient receives and uses the gift card in a step 144. A gift card delivery confirmation 146 is returned to the organizer 102, whether or not the gift card itself is ever used. A step 148 issues a gift delivered and thank you message to all participants. A step 150 ends the organizer's role, and a step 152 similarly concludes the contributors' communications.

Website 104 presents a format and organization that will be familiar to Internet users. Web surfers who find the Home Page on the Internet are offered standard ABOUT US, and CONTACT US links. They are also provided links to ORGANIZER-NEW USER INFORMATION and GIFT REQUEST pages. Here, potential organizers can register and set up their gift giving. Table-I summarizes the identity information collected about the organizer in step 112. Table-II summarizes the information about the gift and the recipient in step 120. Table-III summarizes the email sent to the contributors in step 122. Table-IV lists a typical contribution page as seen in step 132.

TABLE I
identity information collected about the organizer
Organizer - New User Information

First Name, Last Name
Address
City, State, Zip
Outside US
Email address
Confirm Email address (which becomes Login ID)
Password (5 digits) • Retype Password
Remember me

TABLE II
information about the gift and the recipient
Gift Request

```
Recipient name
Recipient email if available
Ship to address
  -recipient (last name, first name, address, city, state, zip)
  -organizer
  -other address
Delivery via UsPS 5-7 days
Deadline for contributions
Calendar (pop-up that shows the 10 day window when any date is
highlighted)
Occasion (scroll)
  Class gift
  Birthday
  Wedding
  Anniversary, Baby Shower Christmas
  Bar/Bat Mitzvah, Executive gift
Vendor Categories (scroll)
  Books and Music (with pop-up vendors)
  Charity
  Clothing
  Electronics
  Entertainment
  Food
  Health and Beauty
  Home
  Kids and Toys
  Office Sports
Vendor Choice
  List of Vendors (to be supplied)
Organizer must make first contribution
  Link to contribution page
Credit Card information (name on card, type of card, card#,
expiration, CCV)
  Billing address if different from above
  Verify Organizer credit card
Contributor names and emails (create address book)
Contribution reminder email dates (2 weeks, 1 week, 3 days generated by
chosen deadline date)
```

TABLE III
the email sent to the contributors
Contributor Email

From Organizer announcing \grave{ }Organizer name has invited you to
share in a group gift
FromEveryone for “name”. Click the link below to find out how:
Link to contribution page

TABLE IV
a typical contribution page
Contribution Page

Blurb - about Organizer, Recipient, event, Vendor chosen (written by
Organizer to Contributors)
Contributor's First Name, Last Name
Address
City, State, Zip
Outside US
Credit card type
Credit card number
Expiration date, CCV
Billing address if different from above
Contribution amount
Credit card authorization
Credit card confirmation via email to Contributor (receipt)
Contribution update to Organizer summary page

Table-V outlines one way to implement the organizer gift page details provided by step 120.

TABLE V
Group Gift Summary Page

Login in (email)
Password
Summary page includes all contributors (including Organizer), recipient,
vendor, deadline, contribution yes/no, running total of contributions

Backend processing at the website server provides a system administrator with access to group details, contributions, emails, addresses, etc. Credit cards are typically processed at time of use. When the Deadline arrives that was set by the organizer, the gift card is purchased. The gift card serial number is recorded/scanned, and the gift card is shipped. A tracking process for shipping records, USPS tracking, and delivery confirmation are included. A thank you message and survey follow up email are sent to the organizer and contributors. Summary page for FromEveryone includes all contributors (including organizer), recipient, individual contribution, contribution total per recipient, vendor, deadline, contribution yes/no, credit card authorization (payment valid), gift card serial number, shipped, delivery date, USPS tracking number.

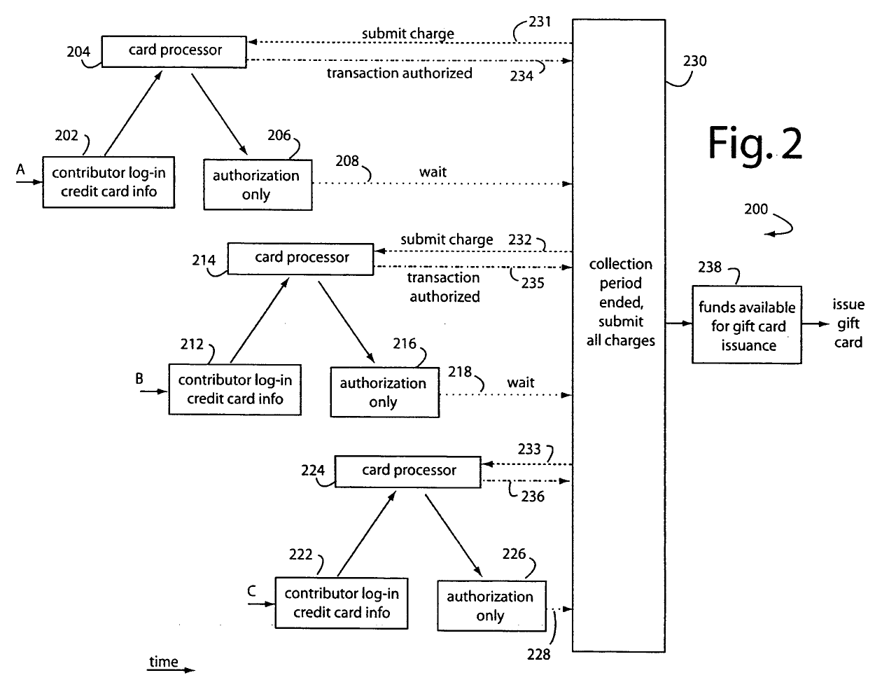

FIG. 2 represents how a bank authorization is obtained for each contributor's credit card at the time of their contribution, and how these all remain pending until they are submitted for payment by the gift deadline date. A method embodiment of the present invention is referred to herein by the general reference numeral 200. The method 200 begins with a first contributor-A disclosing their credit card information and amount contributed in a step 202. A first card processor 204 is accessed and an authorization is obtained and held in a step 206. The transaction will be an authorization only during a waiting period 208. Later, a second contributor-B discloses their credit card information and amount contributed in a step 212. A second card processor 214 is accessed and an authorization is obtained and held in a step 216. The transaction will be an authorization only during a waiting period 218. A last contributor-C also discloses their respective credit card information and the amount they want to be contributed in a step 222. A third card processor 224 is accessed and an authorization is obtained and held in a step 226. The transaction will be an authorization only during a waiting period 228.

A step 230 represent the point in time when the gift collection period has ended, for whatever reason, and all charges are submitted 231-233 to corresponding card processors 204, 214, and 224. Transaction authorizations 234-236 make funds available and only then actually put through the charges to the respective credit card accounts. In another embodiment of the present invention, the transaction authorization 234-236 may occur at a set deadline, when a minimum dollar value of collections is met, or within 30 days of the initial authorization. Finally, the collected funds are combined in a step 238 and the gift card is issued.

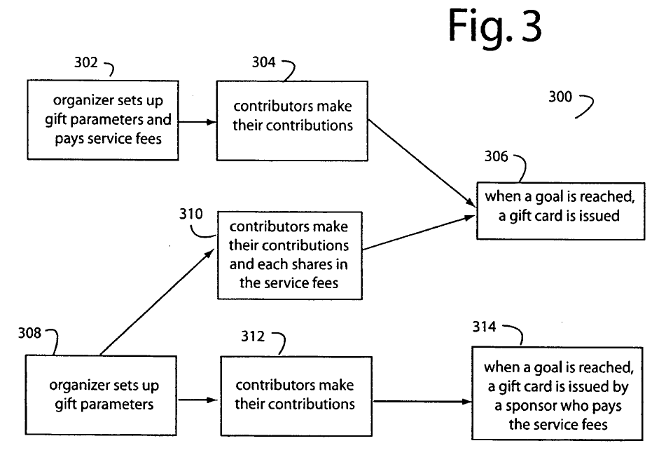

FIG. 3 shows a method 300 in which alternative ways the Website operation fees can be supported by the Organizer, Contributors, and/or Sponsors. In a first scenario, an organizer sets up the parameters of the collective gift initiative and pays the service fees in a step 302. The contributors make their individual contributions independently in a step 304. When a goal is reached, e.g., a deadline, the gift card is issued in a step 306. In a second scenario, the organizer does not pay the service fees. In a step 308 the organizer simply sets up the collective gift initiative and launches it. In a step 310, the contributors each share in paying the service fees. In a third scenario, neither the organizer nor the contributors have to support the service fees, as in steps 308 and 312. A sponsor pays the fees in a step 314. For example, The Home Depot may sponsor the service fees if the gift card being issued is a HOME DEPOT gift card.

While the present invention has been described with reference to several particular example embodiments, those skilled in the art will recognize that many changes may be made thereto without departing from the spirit and scope of the present invention, which is set forth in the following claims.

What is claimed is:

1. A system for purchasing a collective gift, the system comprising:
a gift collection website hosted on a computer server having a computer program, the computer program having;
a first code segment for initiating a gift collection based upon receiving a request from an organizer;
a second code segment for creating a new gift account based on information provided by the organizer;
a third code segment for generating and sending invitations to a plurality of contributors;
a fourth code segment for receiving payment information from one of the organizer and the plurality of contributors, and processing said payment information; and
a fifth code segment for initiating the issuance of a gift to a recipient.

2. The collective gift purchasing system of claim 1, wherein the gift is a gift card.

3. The collective gift purchasing system of claim 1, wherein the information provided by the organizer comprises identification of the gift and definition of a collection period.

4. The collective gift purchasing system of claim 1, wherein the invitations are sent to the plurality of contributors via email.

5. The collective gift purchasing system of claim 1, wherein the payment information is processed as it is received by the computer server.

6. The collective gift purchasing system of claim 3, wherein the defined collection period has an end and the payment information is processed at the end of the collection period.

7. The collective gift purchasing system of claim 1, wherein the organizer is charged a service fee.

8. The collective gift purchasing system of claim 1, wherein a service fee is charged to the anyone sending payment information to the gift collection website.

9. The collective gift purchasing system of claim 1, wherein a thank you message is produced following the purchase of the gift.

10. The collective gift purchasing system of claim 3, wherein the collection period is defined by a predetermined value of the gift.

11. The collective gift purchasing system of claim 3, wherein the collection period is defined by a predetermined time period.

12. A method for collaboratively funding a gift, the method comprising:
establishing a gift collection site following a request from an organizer;
inviting at least one of a plurality of contributors to visit the gift collection site;
collecting payment information from at least one of a plurality of contributors;
processing the collected payment information;
purchasing a gift card using the collected payment information; and,
issuing the gift card to a recipient.

13. The method of claim 12, further comprising hosting the gift collection site on an Internet website.

14. The method of claim 12, further comprising contacting one of the plurality of contributors using email.

15. The method of claim 12, further comprising publishing the plurality of contributors names on the gift collection site.

16. The method of claim 12, further comprising processing the collected payment information after a collection period established by the organizer has ended.

17. The method of claim 12, further comprising producing a thank you message following the purchase of the gift card.

18. The method of claim 12, further comprising assisting visitors to the gift collection site.

19. A system for purchasing and delivering a collective gift comprising:
initiating a gift collection site on an Internet website following a request from a first person;
contacting a second person via email regarding the gift collection site;
offering assistance to the second person at the gift collection site;
collecting payment information, including a credit card number, from one of the first or second persons using the gift collection site;
processing payment information after the collection period established by the first person has ended;
purchasing a gift card;
delivering the gift card to a third person;
generating a thank you card message following the purchase of the gift card.
